(19) United States
(12) Patent Application Publication
(10) Pub. No.: US 2026/0057760 A1
(43) Pub. Date: Feb. 26, 2026

(54) BLUETOOTH HEADSET AND CONTROL METHOD AND DEVICE THEREFOR, READABLE STORAGE MEDIUM, AND TERMINAL

(71) Applicant: RDA Microelectronics (Beijing) Co., Ltd., Beijing (CN)

(72) Inventor: Chongyu WANG, Shanghai (CN)

(21) Appl. No.: 19/102,759

(22) PCT Filed: Sep. 14, 2022
(86) PCT No.: PCT/CN2022/118632

§ 371 Date: Feb. 10, 2025

(30) Foreign Application Priority Data
Aug. 10, 2022 (CN) 202210959206.1

(51) Int. Cl. G08B 25/01; A42B 3/04; G01C 21/16; G08B 3/10; G08B 21/04; H04R 1/10; H04R 29/00

(52) U.S. Cl. CPC G08B 25/016; A42B 3/046; G01C 21/165; G08B 3/10; G08B 21/043; G08B 21/0446; H04R 1/1041; H04R 29/001

(57) ABSTRACT

A Bluetooth headset and a control method and device therefor, a readable storage medium, and a terminal. The control method for the Bluetooth headset includes: acquiring attitude information of the Bluetooth headset (S11); determining an attitude of a wearer of the Bluetooth headset according to the attitude information (S12); if it is determined that the attitude of the wearer is a falling-to-the-ground attitude, controlling an Internet of things communication module to send an emergency rescue request to a preset emergency contact (S13), where the emergency rescue request includes any one of the following: sending rescue information to the preset emergency contact, and making a rescue call to the preset emergency contact, where the Internet of things communication module is built in the Bluetooth headset.

### CROSS-REFERENCE TO RELATED APPLICATIONS

This application is a National Stage of International Application No. PCT/CN2022/118632, filed on Sep. 14, 2022, which claims priority to Chinese Patent Application No. 202210959206.1, filed to China National Intellectual Property Administration on Aug. 10, 2022 and entitled “BLUETOOTH HEADSET AND CONTROL METHOD AND DEVICE THEREFOR, READABLE STORAGE MEDIUM, AND TERMINAL”. The afore-mentioned applications are hereby incorporated by reference in their entireties.

### TECHNICAL FIELD

Embodiments of the present disclosure relate to the field of Bluetooth headset technologies and, in particular, to a Bluetooth headset and control method and device therefor, a readable storage medium and a terminal.

### BACKGROUND

At present, more and more people begin to pay attention to and participate in sports such as motorcycle riding, bicycle riding, and outdoor adventures carried out by backpackers. However, these sports usually involve a certain degree of danger, especially motorcycle riding.

In these sports, some unexpected situations are likely to occur, such as a rider falling off during riding, or a backpacker falling down during adventure. When a rider or a backpacker falls to the ground, it is sometimes inconvenient to use a mobile phone for help. In this way, a better rescue opportunity may be delayed.

### SUMMARY

The embodiments of the present disclosure provide a control method for a Bluetooth headset, including: acquiring attitude information of the Bluetooth headset; determining an attitude of a wearer of the Bluetooth headset according to the attitude information; controlling an Internet of Things communication device to send an emergency rescue request to a preset emergency contact if it is determined that the attitude of the wearer is a falling-to-the-ground attitude, where the emergency rescue request includes any one of the following: sending rescue information to the preset emergency contact, and making a rescue call to the preset emergency contact, where the Internet of Things communication device is built in the Bluetooth headset.

The embodiments of the present disclosure also provide a Bluetooth headset, including: a headset body; a Bluetooth communication device, arranged in the headset body; an Internet of Things communication device, arranged in the headset body; an attitude detection device, configured to collect attitude information of the Bluetooth headset; and a control device for the Bluetooth headset, where the control device is connected with the Bluetooth communication device, the Internet of Things communication device and the attitude detection device, and the control device is configured to: acquire attitude information of the Bluetooth headset; determine an attitude of a wearer of the Bluetooth headset according to the attitude information; control the Internet of Things communication device to send an emergency rescue request to a preset emergency contact in response to determining that the attitude of the wearer is a falling-to-the-ground attitude, wherein the emergency rescue request comprises any one of the following: sending rescue information to the preset emergency contact and making a rescue call to the preset emergency contact.

The embodiments of the present disclosure also provide a computer-readable storage medium on which a computer program is stored, where the computer program, when executed by a processor, executes the steps of a control method for the Bluetooth headset.

The embodiments of the present disclosure also provide a terminal, including a memory and a processor, where a computer program capable of running on the processor is stored in the memory, and when the processor runs the computer program, the following steps of a control method for the Bluetooth headset are executed: acquiring attitude information of a Bluetooth headset; determining an attitude of a wearer of the Bluetooth headset according to the attitude information; controlling an Internet of Things communication device to send an emergency rescue request to a preset emergency contact in response to determining that the attitude of the wearer is a falling-to-the-ground attitude, wherein the emergency rescue request comprises any one of the following: sending rescue information to the preset emergency contact and making a rescue call to the preset emergency contact, wherein the Internet of Things communication device is built in the Bluetooth headset.

### BRIEF DESCRIPTION OF DRAWINGS

FIG. 1 is a flowchart of a control method for a Bluetooth headset provided by an embodiment of the present disclosure.

FIG. 2 is a flowchart of another control method for a Bluetooth headset provided by an embodiment of the present disclosure.

FIG. 3 is a schematic structural diagram of a control device for a Bluetooth headset provided by an embodiment of the present disclosure.

### DESCRIPTION OF EMBODIMENTS

As mentioned above, in these sports, some unexpected situations are likely to occur, such as a rider falling off during riding, or a backpacker falling down during adventure. When a rider or a backpacker falls to the ground, he or she may lose consciousness or have restricted mobility, and may be unable to take out a satellite phone or be too far away from the satellite phone to get it, or even in a coma and unable to carry out self-rescue. In this way, a better rescue opportunity may be delayed.

The technical problem solved by the embodiments of the present disclosure is how to improve the convenience and timeliness of sending rescue requests. In order to solve the above problems, in the embodiments of the present disclosure, by acquiring the attitude information of the Bluetooth headset, the attitude of the wearer of the Bluetooth headset is determined according to the attitude information. When it is determined that the attitude of the wearer is the falling-to-the-ground attitude, the Internet of Things communication module built in the Bluetooth headset is controlled to send the emergency rescue request, such as sending rescue information to a preset emergency contact, making a rescue call to the preset emergency contact, etc. Usually, the Bluetooth headset is worn by the wearer, and the Internet of Things communication module is built in the Bluetooth headset, so that when the wearer of the Bluetooth headset falls to the ground, without relying on other devices, the Bluetooth headset can automatically control the Internet of Things communication module of the Bluetooth headset to send the emergency rescue request to the preset emergency contact, thereby improving the convenience and timeliness of sending rescue requests.

In order to make the above objects, features and beneficial effects of the embodiments of the present disclosure more obvious and easy to understand, specific embodiments of the present disclosure will be described in detail with the accompanying drawings.

The embodiments of the present disclosure provide a control method for a Bluetooth headset, which is used to control the Bluetooth headset. The control method for the Bluetooth headset provided in the following embodiments can be executed by a chip with a control function in the Bluetooth headset or by a chip module with a control function in the Bluetooth headset.

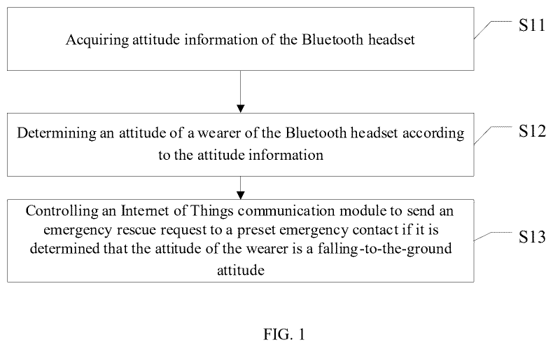

Specifically, referring to FIG. 1, a flowchart of a control method for a Bluetooth headset provided by an embodiment of the present disclosure is shown, and the control method for the Bluetooth headset may specifically include the following steps:

S11, acquiring attitude information of the Bluetooth headset;

S12, determining an attitude of a wearer of the Bluetooth headset according to the attitude information;

S13, controlling an Internet of Things communication module to send an emergency rescue request to a preset emergency contact if it is determined that the attitude of the wearer is a falling-to-the-ground attitude.

The emergency rescue request includes any one of the following: sending rescue information to the preset emergency contact, and making a rescue call to the preset emergency contact, where the Internet of Things communication module is built in the Bluetooth headset.

The information of the emergency contact can be preset and stored, and the information of the emergency contact can be stored locally in the Bluetooth headset or stored in a user equipment to which the Bluetooth headset is connected via Bluetooth. If the emergency contact is stored in the user equipment to which the Bluetooth headset is connected via Bluetooth, the Bluetooth headset can obtain the information of the emergency contact from the user equipment. The information of the emergency contact includes at least a phone number of the emergency contact, and may also include a name of the emergency contact. The emergency contact can be a relative or a friend of the wearer, and may also be a professional rescue agency, and so on.

There are many ways to set the information of the emergency contact. For example, an emergency contact setting button can be set on the Bluetooth headset, and the information of the emergency contact can be set through the emergency contact setting button. Another example is to set the information of the emergency contact through the user equipment to which the Bluetooth headset is connected via Bluetooth. Specifically, the user equipment can be provided with an application software (APP) or an application program corresponding to the Bluetooth headset, and the information of the emergency contact can be configured through the APP or application program. It can be understood that other ways can also be used to configure the information of the emergency contact, and no further examples will be given here.

It can be seen from the above that by acquiring attitude information of a Bluetooth headset, the attitude of the wearer of the Bluetooth headset is determined according to the attitude information. When it is determined that the attitude of the wearer is the falling-to-the-ground attitude, the Internet of Things communication module built in the Bluetooth headset is controlled to send the emergency rescue request, such as sending rescue information to a preset emergency contact, making a rescue call to the preset emergency contact, etc. Usually, the Bluetooth headset is worn by the wearer, and the Internet of Things communication module is built in the Bluetooth headset, so that when the wearer of the Bluetooth headset falls to the ground, without relying on other devices, the Bluetooth headset can automatically control the Internet of Things communication module of the Bluetooth headset to send the emergency rescue request to the preset emergency contact, thereby improving the convenience and timeliness of sending rescue requests.

In a specific implementation, the attitude information may include a three-axis attitude angle and an angular rate of the Bluetooth headset. Assuming that the direction directly in front of the Bluetooth headset (that is, the wearer's traveling direction in a horizontal direction) is an X axis, the direction directly to the left is a Y axis, and the direction vertically upward is a Z axis. Specifically, the three-axis attitude angle includes three attitude angles. The three attitude angles are defined as: pitch angle (pitch): an angle between the X axis and the horizontal plane, corresponding to a forward pitch angle and a backward pitch angle of the wearer (or the Bluetooth headset); roll angle (roll): an angle between the Y axis and the horizontal plane, corresponding to a left lateral deflection angle and a right lateral deflection angle of the wearer (or the Bluetooth headset); yaw angle (yaw): an angle between the Z axis and the vertical direction, corresponding to a rotation angle of the wearer (or the Bluetooth headset) around the Z axis.

In some embodiments, the attitude information of the Bluetooth headset acquired in S11 can be collected by an Inertial Measurement Unit (IMU) sensor built in the Bluetooth headset. The IMU sensor is a device for measuring the three-axis attitude angle, angular rate and acceleration of an object. Usually, the IMU sensor includes three accelerometers and three gyroscopes. The accelerometers detect acceleration signals of the Bluetooth headset in three independent axes in a carrier coordinate system, while the gyroscopes detect angular velocity signals of the Bluetooth headset relative to a navigation coordinate system. A spatial datum is a set of reference points, lines and surfaces for spatial measurement and calculation, and the coordinate system is a tool for spatial datum transmission. The commonly used coordinate systems in an inertial navigation include an inertial coordinate system, an earth coordinate system, a navigation coordinate system and a carrier coordinate system. In the navigation coordinate system, a geographical coordinate system is often used as a reference coordinate system for solving navigation parameters, that is, a North-East-Up coordinate system, also known as a Station-Centered coordinate system. The coordinate origin is the center of gravity of a carrier, the X axis points to the east (E) in the local horizontal plane and the Y axis points to the north (N) in the local horizontal plane. The Z axis points to the sky (U) along the local vertical line. The azimuth relation of the geographical coordinate system with respect to the earth coordinate system is the geographical location (longitude λ, latitude φ) of the carrier. The navigation coordinate system is often used to describe a motion attitude and velocity of the Bluetooth headset (moving carrier) in the local coordinate system. The coordinate origin of the carrier coordinate system is the center of gravity of the carrier, with the X axis pointing to the right along the transverse axis of the carrier, the Y axis pointing forward along the longitudinal axis of the carrier, and the Z axis pointing upward along the vertical axis of the carrier, that is, the right-front-up coordinate system. The relationship between the carrier coordinate system and the navigation coordinate system can be expressed by an attitude matrix of the carrier. The angular velocity and acceleration of the Bluetooth headset in a three-dimensional space are measured in order to calculate the attitude of the Bluetooth headset, where the carrier refers to the Bluetooth headset.

In a specific implementation, S12 can be realized in various ways. That is, there are many ways to determine the attitude of the wearer of the Bluetooth headset according to the attitude information, specifically:

In some non-limiting embodiments, when a maximum variation of the acceleration within a set duration is greater than a set variation threshold, it is determined that the attitude of the wearer is the falling-to-the-ground attitude.

In hiking, mountain climbing, motorcycle riding, bicycle riding and other scenarios, the variation of the acceleration of the wearer in a normal attitude fluctuates little, usually within a relatively stable range. When the wearer's attitude changes, such as from the normal attitude to the falling-to-the-ground attitude, the maximum variation of the acceleration within a set duration is usually greater than the set variation threshold. Therefore, it can be determined that the wearer is in the falling-to-the-ground attitude by determining whether the maximum variation of the acceleration of the Bluetooth headset within the set duration is greater than the set variation threshold.

In different application scenarios, due to different velocities of hiking, motorcycle riding or bicycle riding, etc., the time it takes for the wearer to change from the normal attitude to the falling-to-the-ground attitude may be slightly different. In specific embodiments, the specific value of the set duration can be set according to the type of application scenario where the wearer of the Bluetooth headset is located, and the set durations corresponding to in different types of application scenarios can be the same or different.

Further, the types of the application scenarios can be configured, and the set duration corresponding to each type of application scenario can be set. The types of the application scenarios can include at least one of the following: hiking, mountain climbing, motorcycle riding, bicycle riding, etc. The wearer can choose the corresponding scenario type according to the actual application scenarios.

In some other non-limiting embodiments, when the acceleration is greater than a preset acceleration threshold, it is determined that the attitude of the wearer is the falling-to-the-ground attitude.

When the attitude of the wearer suddenly changes, the acceleration of the Bluetooth headset will also change. For example, if the wearer changes from the normal attitude to the falling-to-the-ground attitude, the acceleration of the Bluetooth headset will increase. In this way, when the acceleration is greater than the preset acceleration threshold, it can be determined that the attitude of the wearer is the falling-to-the-ground attitude.

In still other non-limiting embodiments, an inclination angle of the Bluetooth headset is determined according to the three-axis attitude angle, and if the inclination angle is greater than a preset angle threshold, it is determined that the attitude of the wearer is the falling-to-the-ground attitude, where the inclination angle refers to the inclination angle of the Bluetooth headset relative to the horizontal plane (XY plane).

Because the gyroscopes measure an angular velocity, that is, a rotating velocity of the Bluetooth headset, the rotating angle of the Bluetooth headset within a certain period can be obtained by multiplying the velocity with the time. However, the angle obtained by integral operation has its own error, and the error will be accumulated and intensified with the accumulation of time.

The accelerometers can measure the acceleration of the Bluetooth headset. Gravitational acceleration is an acceleration of an object under the action of gravity. When the Bluetooth headset is at rest, the value measured by the accelerometer is equal to the gravitational acceleration 1 g, which is about 9.8 meters per square second. The direction of the gravitational acceleration g is always vertically downward (that is, toward the center of the earth). According to an acceleration component of the gravitational acceleration on its X axis and an acceleration component on its Y axis, the inclination angle of the Bluetooth headset relative to the horizontal plane can be calculated. The attitude of the wearer can be determined by combining the inclination angle of the Bluetooth headset relative to the horizontal plane, which is obtained based on the acceleration component of gravitational acceleration on its X axis and the acceleration component on its Y axis. Specifically, in some other non-limiting embodiments, if the inclination angle of the Bluetooth headset relative to the horizontal plane, which is obtained through calculation on the basis of the acceleration component of the gravitational acceleration in the X-axis direction and the acceleration component in the Y-axis direction, is greater than a first angle threshold, and the inclination angle of the Bluetooth headset, which is determined according to the three-axis attitude angle, is greater than a second angle threshold, it is determined that the attitude of the wearer is the falling-to-the-ground attitude.

Based on this, in order to improve the accuracy of the attitude determination of the Bluetooth headset, in some other non-limiting embodiments, when the maximum variation of the acceleration is greater than the set variation threshold within a set duration, the inclination angle of the Bluetooth headset is determined according to the three-axis attitude angle, and if the inclination angle is greater than the preset angle threshold, it is determined that the attitude of the wearer is the falling-to-the-ground attitude, where the inclination angle refers to the inclination angle of the Bluetooth headset relative to the horizontal plane (XY plane).

Based on this, in order to improve the accuracy of the attitude determination of the Bluetooth headset, in some other non-limiting embodiments, when the acceleration is greater than the preset acceleration threshold, the inclination angle of the Bluetooth headset is determined according to the three-axis attitude angle, and the inclination angle is greater than the preset angle threshold, it is determined that the attitude of the wearer is the falling-to-the-ground attitude, where the inclination angle refers to the inclination angle of the Bluetooth headset relative to the horizontal plane (XY plane).

Based on this, in order to improve the accuracy of the attitude determination of the Bluetooth headset, in some other embodiments, when the maximum variation of the acceleration is greater than the set variation threshold and the acceleration is greater than the preset acceleration threshold within a set duration, the inclination angle of the Bluetooth headset is determined according to the three-axis attitude angle, and if the inclination angle is greater than the preset angle value, it is determined that the attitude of the wearer is the falling-to-the-ground attitude, where the inclination angle refers to the inclination angle of the Bluetooth headset relative to the horizontal plane (XY plane).

In this way, by comprehensively considering the variation of the acceleration and the inclination angle of the Bluetooth headset relative to the horizontal plane, the accuracy of the determination on whether the wearer falls to the ground can be improved. In some scenarios, the wearer may not be injured or slightly injured after falling, and at this time, the wearer may not need to send an emergency rescue request. In order to improve the accuracy of sending the emergency rescue request, so as to make the emergency rescue request meet the actual needs of the wearer more, in the embodiments of the present disclosure, before the controlling the Internet of Things communication module to send the emergency rescue request to the preset emergency contact, the control method for the Bluetooth headset may further include: starting timing from the moment when it is determined that the attitude of the wearer is the falling-to-the-ground attitude, and if the attitude of the wearer remains in the falling-to-the-ground attitude for a first duration, entering a warning mode and outputting a first warning alert, where the first warning alert is used to alert the wearer that he or she is in the falling-to-the-ground attitude.

In a specific implementation, a timer set in the Bluetooth headset can be used for timing; the time information can also be obtained from the user equipment connected to the Bluetooth headset via Bluetooth communication, and the timing can be performed based on the obtained time information; and the timing can also be done by querying the time through the Internet of Things communication module.

For example, when it is determined that the wearer is in the falling-to-the-ground attitude, the Internet of Things communication module is triggered to start inquiring about the current time and record the duration of the falling-to-the-ground attitude. That is to say, a duration of the falling state from the moment when the wearer starts to be in the falling-to-the-ground attitude until the current moment is recorded.

The first duration can be set according to the actual demand. For example, the first duration can be a proper duration, e.g. one minute or two minutes, so as to ensure that when the wearer falls, an emergency rescue request can be sent in time. The first duration can be adjusted according to the actual application scenario. When the actual application scenario is located in a remote area, it takes a relatively long time for the rescue to arrive, or when it is far away from rescue sites such as hospitals, the first duration can be shorter to ensure that an emergency rescue request can be sent in time when the wearer falls.

If the wearer remains the falling-to-the-ground attitude for the first duration, a warning mode is entered. In the warning mode, a first warning alert is output. The first warning alert is used to alert the wearer that he or she is in the falling-to-the-ground attitude. The first warning alert can be issued by playing an alarm sound or a prompt sound through an earpiece of the Bluetooth headset. The first warning alert is given to the wearer by playing an alarm sound or a prompt sound to call the wearer, which can prevent the wearer who falls to the ground from having a blurred consciousness.

In some non-limiting embodiments, the warning mode is exited in response to an instruction for exiting the warning mode. If it is determined that the attitude of the wearer is still the falling-to-the-ground attitude according to the attitude information within a second duration after exiting the warning mode, the warning mode is entered again and a second warning alert is output.

Specifically, in the warning mode, it can be determined whether the instruction for exiting the warning mode is received or generated. When the instruction for exiting the warning mode is received or detected, the warning mode is exited. After the warning mode is exited, the output of the first warning alert will be stopped.

The attitude of the wearer of the Bluetooth headset is continued to be determined according to the attitude information within the second duration after exiting the warning mode. Timing is started from the moment of exiting the warning mode, and if it is determined that the attitude of the wearer is still the falling-to-the-ground attitude according to the attitude information within the second duration after exiting the warning mode, the warning mode is entered again and a second warning alert is output.

The alerting mode of the second warning alert can be the same as or different from that of the first warning alert.

In some embodiments, an alerting intensity of the second warning alert may be stronger than that of the first warning alert. For example, when the second warning alert and the first warning alert are issued by playing an alarm sound or a prompt sound through an earpiece of the Bluetooth headset, the volume of the alarm sound or the prompt sound of the second warning alert may be louder than that of the first warning alert. As another example, the second warning alert is issued by playing an alarm sound or a prompt sound through the speaker on the Bluetooth headset. For another example, the alarm sound or the prompt sound is played through the earpiece of the Bluetooth headset, and at the same time, an alarm sound or a prompt sound is played through the speaker on the Bluetooth headset, so that the alerting effect of the second warning alert is further improved by alerting both the wearer and passers-by at the same time.

Further, before exiting the warning mode in response to the instruction to exit the warning mode, it further includes: generating the instruction for exiting the warning mode.

In some non-limiting embodiments, when an operation of exiting the warning mode is detected, the instruction for exiting the warning mode is generated.

For example, the Bluetooth headset can be provided with a button to exit the warning mode, and when the operation of the button to exit the warning mode is detected, an instruction for exiting the warning mode can be generated. The button to exit the warning mode can be a virtual touch button or a physical button, which is not limited in the embodiments of the present disclosure.

For another example, a Bluetooth headset can be provided with a voice collection module and a voice recognition module, where the voice collection module can collect voice information, and the voice recognition module can perform voice recognition on the collected voice information. Detecting the operation of exiting the warning mode can be achieved by receiving a voice instruction for exiting the warning mode. When it is determined that the voice instruction for exiting the warning mode is received, the instruction for exiting the warning mode is generated.

For another example, a motion trajectory of the Bluetooth headset can be determined based on the attitude information of the Bluetooth headset. The operation of exiting the warning mode can be defined as when the motion trajectory of the Bluetooth headset is a preset motion trajectory. When the motion trajectory of the Bluetooth headset is the preset trajectory, the instruction for exiting the warning mode is generated. The set motion trajectory can be set in advance and stored in the Bluetooth headset or the user equipment connected with the Bluetooth headset via Bluetooth.

In some other non-limiting embodiments, when it is determined according to the attitude information that the attitude of the wearer is switched from the falling-to-the-ground attitude to a normal attitude, the instruction for exiting the warning mode is generated, and the normal attitude is an attitude other than the falling-to-the-ground attitude. The normal attitude can be riding attitude, hiking attitude, standing attitude, etc.

Specifically, timing is started from exiting the warning mode, and if within a second duration after exiting the warning mode, the attitude of the wearer is determined to be the normal attitude according to the attitude information, or the attitude is switched from the falling-to-the-ground attitude to the normal attitude, the instruction for exiting the warning mode is generated.

By configuring the first warning mode and/or the second warning mode, the accuracy of determining that the wearer is in the falling-to-the-ground attitude and triggering to send the emergency rescue request to the preset emergency contact can be improved, and the probability of wrongly judging that the wearer is in a dangerous state can be effectively reduced. In addition, by constantly calling the wearer in the falling-to-the-ground attitude through the first warning mode and/or the second warning mode, the wearer in the falling-to-the-ground attitude can be prevented from being having a blurred consciousness.

The specific value of the second duration can be pre-configured, which can be the same as or different from the first duration.

In some embodiments, in the above S13, the wearer can actively trigger an emergency rescue operation to control the Internet of Things communication module to send the emergency rescue request to the preset emergency contact. For example, there is an emergency rescue button on the Bluetooth headset, which can trigger an emergency rescue when operated. The emergency rescue button can be a virtual touch button or a physical button.

In some other embodiments, in the above S13, controlling the Internet of Things communication module to send the emergency rescue request to the preset emergency contact can be realized in the following ways: if exiting the warning mode is not detected for a third duration after entering the warning mode, controlling the Internet of Things communication module to send the emergency rescue request to the preset emergency contact.

Usually, if the wearer falls to the ground, if the wearer is conscious and has a certain degree of mobility, the warning mode can be turned off by himself or herself, or by changing the current attitude (such as sitting up or standing from the falling-to-the-ground attitude). Timing is started after entering the warning mode. If exiting from the warning mode is not detected for the third duration, it may happen that the wearer has a blurred consciousness or limited mobility, and thus the warning mode cannot be turned off. At this time, the Internet of Things communication module is controlled to send the emergency rescue request to the preset emergency contact.

In some embodiments, the Internet of Things communication module can be controlled to send rescue information to all emergency contacts. Among them, the Internet of Things communication module can be controlled to send the rescue information in the form of text messages to all the emergency contacts. It is also possible to control the Internet of Things communication module to send the rescue information to the emergency contacts one by one according to their priorities.

In some other embodiments, the Internet of Things communication module can be controlled to call the emergency contacts one by one according to their priorities until the call is connected.

In still other embodiments, the Internet of Things communication module can be controlled to send the rescue information to all the emergency contacts, and at the same time, the Internet of Things communication module can be controlled to call the emergency contacts one by one according to the priorities of the emergency contacts until the call is connected. In this way, the success rate of the emergency rescue request can be further improved.

Further, location information of the Bluetooth headset is obtained, where the location information is used to indicate the location of the wearer, and the rescue information includes the location information. The location information is included in the sent rescue information, so that the current location of the wearer can be easily known quickly, and the rescue can be carried out in time.

The location information may come from a positioning device set in the Bluetooth headset, or from the Internet of Things communication module, or also from the user equipment connected to the Bluetooth headset through Bluetooth communication.

The rescue information may also include a name, a gender, a blood type and other information of the wearer. Among them, information such as the name, the gender, the blood type, etc. is preset by the wearer with the authorization of the wearer, and can be stored in the Bluetooth headset or the user equipment connected with the Bluetooth headset through Bluetooth communication.

In a specific implementation, the above-mentioned Internet of Things communication module may include a narrow band Internet of Things (NB-IoT) communication module.

An Internet of Things card can be installed in the Bluetooth headset, and the Bluetooth headset can communicate with other devices at any time through the installed Internet of Things card and the Internet of Things communication module.

In some embodiments, the Bluetooth headset is installed on a helmet, and the control method further includes: detecting whether the Bluetooth headset falls off from the helmet; outputting location alert information if the Bluetooth headset is detected to fall off from the helmet. The location alert information is used to indicate the location of the Bluetooth headset.

In some embodiments, the location alert information can be output to a terminal connected with the Bluetooth headset through Bluetooth communication.

In some other embodiments, an alert sound can be output through a speaker, where the speaker is arranged on the Bluetooth headset. Through the output alert sound, it is convenient for the user to determine the falling location of the Bluetooth headset according to the alert sound, and the convenience of finding the Bluetooth headset is improved.

In order to facilitate those skilled in the art to better understand and realize the embodiments of the present disclosure, a specific workflow of the control method for the Bluetooth headset will be described below in combination with a motorcycle riding scenario.

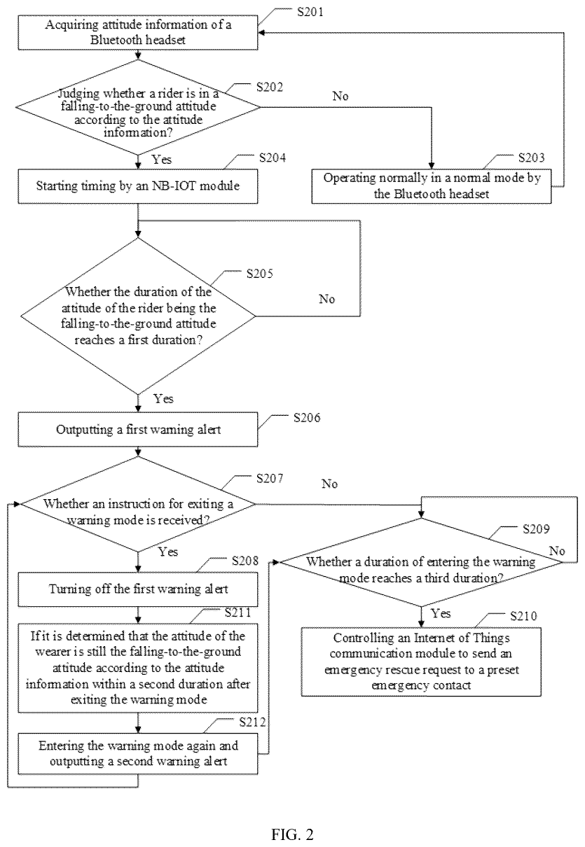

Referring to FIG. 2, a flowchart of another control method for a Bluetooth headset provided by an embodiment of the present disclosure is shown, which specifically includes the following steps:

S201, acquiring attitude information of a Bluetooth headset.

The attitude information of the Bluetooth headset can be collected through an IMU sensor built in the Bluetooth headset.

S202, judging whether a rider is in a falling-to-the-ground attitude according to the attitude information.

If the judgment result is no, that is, the attitude of the rider is a normal attitude, executing S203; if the judgment result is yes, that is, the attitude of the rider is the falling-to-the-ground attitude, executing S204.

S203, operating normally in a normal mode by the Bluetooth headset, and continuing to execute S201.

In the normal mode, the Bluetooth headset can perform a normal communication function and an audio-visual entertainment function, and the IMU sensor can collect the attitude information of the Bluetooth headset regularly or in real time.

S204, starting timing by an NB-IOT module.

If it is determined that the rider is in the falling-to-the-ground attitude, the NB-IOT module starts timing.

S205, judging whether the duration of the attitude of the rider being the falling-to-the-ground attitude reaches a first duration.

If the judgment result is no, continuing to execute S205. If the judgment result is yes, that is, the first duration is reached, executing S206.

S206, outputting a first warning alert.

The first warning alert can be to play an alarm sound or a prompt sound by an earpiece of the Bluetooth headset for warning.

S207, judging whether an instruction for exiting a warning mode is received.

If the judgment result is yes, that is, the instruction for exiting the warning mode is received, executing S208. If the judgment result is no, that is, the instruction for exiting the warning mode is not received, executing S209.

Among them, the rider can independently execute the operation of exiting the warning mode to generate the instruction for exiting the warning mode. It is also possible for the rider to change the attitude to generate the instruction for exiting the warning mode.

S208, turning off the first warning alert.

S209, judging whether a duration of entering the warning mode reaches a third duration.

If the judgment result is yes, that is, the third duration is reached, executing S210; if the judgment result is no, that is, the third duration is not reached, continuing to execute S209.

S210, controlling an Internet of Things communication module to send an emergency rescue request to a preset emergency contact.

After S208, S211 is also included, if it is determined that the attitude of the wearer is still the falling-to-the-ground attitude according to the attitude information within a second duration after exiting the warning mode.

S212, entering the warning mode again and outputting a second warning alert.

After S212, S207 may be continued.

In practice, the number of continuous warning alerts can be configured. When the set number of the warning alerts is reached, S210 may be executed or the warning alerts are no longer triggered.

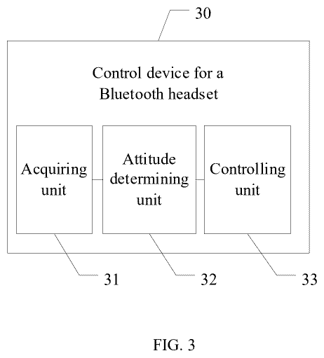

The embodiments of the present disclosure also provide a control device for a Bluetooth headset. Referring to FIG. 3, a schematic structural diagram of a control device for a Bluetooth headset provided by an embodiment of the present disclosure is shown. The control device 30 for a Bluetooth headset may include:
an acquiring unit 31, configured to acquire attitude information of the Bluetooth headset;
an attitude determining unit 32, configured to determine an attitude of a wearer of the Bluetooth headset according to the attitude information;
a controlling unit 33, configured to control an Internet of Things communication module to send an emergency rescue request to a preset emergency contact if it is determined that the attitude of the wearer is a falling-to-the-ground attitude, where the emergency rescue request includes any one of the following: sending rescue information to the preset emergency contact, and making a rescue call to the preset emergency contact, where the Internet of Things communication module is built in the Bluetooth headset.

In a specific implementation, the specific working principle and structure of the control device 30 for the Bluetooth headset can refer to the specific elaboration in the control method for the Bluetooth headset provided in the above embodiments, which will not be repeated here.

In a specific implementation, the above control device for the Bluetooth headset may correspond to a chip with a control function in the Bluetooth headset, such as a system-on-a-chip (SOC), a baseband chip, etc., or a chip module with a data processing function included in the Bluetooth headset; or correspond to a chip module including a chip with a data processing function, or correspond to the Bluetooth headset itself.

The embodiments of the present disclosure also provide a Bluetooth headset, which may include a headset body; a Bluetooth communication module, arranged in the headset body; an Internet of Things communication module, arranged in the headset body; an attitude detection module, configured to collect attitude information of the Bluetooth headset; and a control device for the Bluetooth headset, where the control device is connected with the Bluetooth communication module, the Internet of Things communication module and the attitude detection module. The control device for the Bluetooth headset can adopt the control device for the Bluetooth headset provided in any one of the above embodiments. The specific working principle and structure of the control device for the Bluetooth headset can refer to the description in the above embodiments, which will not be repeated here.

In some embodiments, the Internet of Things communication module includes a narrowband Internet of Things communication module.

In some embodiments, the attitude detection module includes an IMU sensor.

The embodiments of the present disclosure also provide a computer-readable storage medium, on which a computer program is stored, and when the computer program is run by a processor, the steps of the control method for the Bluetooth headset provided by any one of the above embodiments of the present disclosure are executed.

The computer-readable storage medium may include a non-volatile memory or a non-transitory memory, and may also include an optical disk, a mechanical hard disk, a solid state hard disk, etc.

Specifically, in the embodiments of the present disclosure, the processor may be a central processing unit (CPU), and the processor may also be other general-purpose processor, a digital signal processor (DSP), an application specific integrated circuit (ASIC), a field programmable gate array (FPGA) or other programmable logic device, a discrete gate or a transistor logic device, a discrete hardware component, etc. The general processor can be a microprocessor, or the processor can be any processor, etc.

It should also be understood that the memory in the embodiments of the present disclosure may be a volatile memory or a non-volatile memory, or may include both volatile and non-volatile memories. Among them, the non-volatile memory can be a read-only memory (ROM), a programmable ROM (PROM), an erasable PROM (EPROM), an electrically EPROM (EEPROM) or a flash memory. The volatile memory may be a random access memory (RAM), which is used as an external cache. By a way of illustration but not limitation, many forms of random access memory (RAM) are available, such as a static RAM (SRAM), a dynamic random access memory (DRAM), a synchronous DRAM (SDRAM), a double data rate SDRAM (DDR SDRAM), an enhanced SDRAM (ESDRAM), a synchronous link DRAM (Synchlink DRAM) and a direct rambus RAM (DR RAM).

The embodiments of the present disclosure also provide a terminal, which includes a memory and a processor, where a computer program capable of running on the processor is stored in the memory, and when the processor runs the computer program, the steps of the control method for the Bluetooth headset provided in any one of the above embodiments are executed.

The memory is coupled with the processor, and the memory can be located inside or outside the control device for the Bluetooth headset. The memory and the processor may be connected through a communication bus.

The above embodiments can be implemented in whole or in part by software, hardware, firmware or any other combination. When implemented in software, the above embodiments can be implemented in whole or in part in the form of a computer program product. The computer program product includes one or more computer instructions or computer programs. When the computer instructions or the computer programs are loaded or executed on a computer, the processes or functions described in the embodiments of the present disclosure are generated in whole or in part. The computer can be a general-purpose computer, a special-purpose computer, a computer network, or other programmable devices. The computer programs can be stored in a computer-readable storage medium or transmitted from one computer-readable storage medium to another. For example, the computer program can be transmitted from one website, computer, server or data center to another website, computer, server or data center by wired or wireless means.

In several embodiments provided by the present disclosure, it should be understood that the disclosed method and device can be realized in other ways. For example, the device embodiments described above are only schematic; for example, the division of the units is merely logical function division and there may be other division manners in actual implementations; for example, multiple units or components can be combined or integrated into another system, or some features can be ignored or not executed. The units described as separate components may or may not be physically separated, and the components displayed as units may or may not be physical units, that is, they may be located in one place or distributed to multiple network units. Some or all of the units can be selected according to actual needs to achieve the purpose of the solution of the embodiments.

In addition, functional units in the embodiments of the present disclosure may be integrated into one processing unit, or each unit may exist physically alone, or two or more units may be integrated into one unit. The above integrated unit can be realized either in the form of hardware or in the form of hardware-plus-software functional units. For example, for each device or product applied to or integrated in a chip, all the modules/units contained in it can be realized in the form of hardware such as circuits, or at least some modules/units can be realized in the form of software programs, which run on the processor integrated in the chip, and the remaining (if any) modules/units can be realized in the form of hardware such as circuits; for each device or product applied to or integrated in a chip module, all the modules/units contained in it can be realized in the form of hardware such as circuits, different modules/units can be located in the same component (such as a chip, a circuit module, etc.) of the chip module or in different components, or at least some modules/units can be realized in the form of software programs, which run on the processor integrated in the chip module, and the remaining (if any) part of the modules/units can be realized in the form of hardware such as circuits; for each device or product applied to or integrated in a terminal, all the modules/units contained in it can be realized in the form of hardware such as circuits, different modules/units can be located in the same component (for example, a chip, a circuit module, etc.) within the terminal or in different components, or at least some modules/units can be realized in the form of software programs, which run on the processor integrated in the terminal, and the remaining (if any) part of the modules/units can be realized in the form of hardware such as circuits.

It should be understood that the term “and/or” in the description is only a kind of relationship describing related objects, which means that there can be three relationships, for example, A and/or B can mean that A exists alone, A and B exist at the same time, and B exists alone. In addition, the character “/” in the description indicates an “or”relationship between the associated objects in the front and back.

The “multiple” in the embodiments of the present disclosure refers to two or more.

The descriptions first, second, third and the like in the embodiments of the present disclosure are only used to indicate and distinguish the described objects, and there is no order, and they do not mean a special limitation on the number of devices in the embodiments of the present disclosure, and cannot constitute any restrictions on the embodiments of the present disclosure.

It should be pointed out that the serial number of each step in the embodiments does not represent the limitation of the execution order of each step.

Although the present disclosure is disclosed above, the present disclosure is not limited thereto. Any person skilled in the art can make various changes and modifications without departing from the spirit and scope of the present disclosure, so the scope of protection of the present disclosure should be the scope defined by the claims.

The embodiments of the present disclosure provide a control method for a Bluetooth headset, including: acquiring attitude information of the Bluetooth headset; determining an attitude of a wearer of the Bluetooth headset according to the attitude information; controlling an Internet of Things communication device to send an emergency rescue request to a preset emergency contact if it is determined that the attitude of the wearer is a falling-to-the-ground attitude, where the emergency rescue request includes any one of the following: sending rescue information to the preset emergency contact, and making a rescue call to the preset emergency contact, where the Internet of Things communication device is built in the Bluetooth headset.

In an implementation, the attitude information includes a three-axis attitude angle and an acceleration of the Bluetooth headset.

In an implementation, the attitude information is collected by an inertial measurement unit built in the Bluetooth headset.

In an implementation, determining the attitude of the wearer of the Bluetooth headset according to the attitude information includes at least one of the following: when a maximum variation of the acceleration within a set duration is greater than a set variation threshold, determining that the attitude of the wearer is the falling-to-the-ground attitude; and when the acceleration is greater than a preset acceleration threshold, determining that the attitude of the wearer is the falling-to-the-ground attitude; determining an inclination angle of the Bluetooth headset according to the three-axis attitude angle, and if the inclination angle is greater than a preset angle threshold, determining that the attitude of the wearer is the falling-to-the-ground attitude; when the maximum variation of the acceleration within the set duration is greater than the set variation threshold, determining the inclination angle of the Bluetooth headset according to the three-axis attitude angle, and when the inclination angle is greater than the preset angle threshold, determining that the attitude of the wearer is the falling-to-the-ground attitude; when the acceleration is greater than the preset acceleration threshold, determining the inclination angle of the Bluetooth headset according to the three-axis attitude angle, and when the inclination angle is greater than the preset angle threshold, determining that the attitude of the wearer is the falling-to-the-ground attitude; when the maximum variation of the acceleration within the set duration is greater than the set variation threshold and the acceleration is greater than the preset acceleration threshold, determining the inclination angle of the Bluetooth headset according to the three-axis attitude angle, and the inclination angle is greater than the preset angle value, determining that the attitude of the wearer is the falling-to-the-ground attitude; when an inclination angle of the Bluetooth headset relative to a horizontal plane, obtained through calculation on the basis of an acceleration component of a gravitational acceleration in an X-axis direction and an acceleration component in a Y-axis direction, is greater than a first angle threshold, and the inclination angle of the Bluetooth headset determined according to the three-axis attitude angle is greater than a second angle threshold, determining that the attitude of the wearer is the falling-to-the-ground attitude.

In an implementation, before controlling the Internet of Things communication module to send the emergency rescue request to the preset emergency contact, the method further includes: starting timing from a moment when it is determined that the attitude of the wearer is the falling-to-the-ground attitude, and if the attitude of the wearer remains in the falling-to-the-ground attitude for a first duration, entering a warning mode and outputting a first warning alert, where the first warning alert is used to alert the wearer that he or she is in the falling-to-the-ground attitude.

In an implementation, the control method for the Bluetooth headset further includes: exiting the warning mode in response to an instruction for exiting the warning mode; if it is determined that the attitude of the wearer is still the falling-to-the-ground attitude according to the attitude information within a second duration after exiting the warning mode, entering the warning mode again and outputting a second warning alert.

In an implementation, before exiting the warning mode in response to the instruction for exiting the warning mode, the method further includes: generating the instruction for exiting the warning mode when detecting an operation of exiting the warning mode; or, when it is determined that the attitude of the wearer is switched from the falling-to-the-ground attitude to a normal attitude according to the attitude information, generating the instruction for exiting the warning mode, where the normal attitude is an attitude other than the falling-to-the-ground attitude.

In an implementation, the controlling the Internet of Things communication module to send the emergency rescue request to the preset emergency contact includes: if exiting the warning mode is not detected for a third duration after entering the warning mode, controlling the Internet of Things communication module to send the emergency rescue request to the preset emergency contact.

In an implementation, the control method for the Bluetooth headset further includes: acquiring location information of the Bluetooth headset, where the location information is used to indicate a location of the wearer, and the rescue information includes the location information.

In an implementation, the Bluetooth headset is installed on a helmet, and the control method further includes: detecting whether the Bluetooth headset falls off from the helmet; outputting location alert information if the Bluetooth headset is detected to fall off from the helmet.

In an implementation, the outputting the location alert information includes: outputting the location alert information to a terminal connected with the Bluetooth headset through Bluetooth communication; and/or, outputting an alert sound through a speaker, where the speaker is arranged on the Bluetooth headset.

The embodiments of the present invention also provide a control device for a Bluetooth headset, including: an acquiring unit, configured to acquire attitude information of the Bluetooth headset; an attitude determining unit, configured to determine an attitude of a wearer of the Bluetooth headset according to the attitude information; and a controlling unit, configured to control an Internet of Things communication module to send an emergency rescue request to a preset emergency contact if it is determined that the attitude of the wearer is a falling-to-the-ground attitude, where the emergency rescue request includes any one of the following: sending rescue information to the preset emergency contact, and making a rescue call to the preset emergency contact, where the Internet of Things communication module is built in the Bluetooth headset.

1. A control method for a Bluetooth headset, comprising:
acquiring attitude information of a Bluetooth headset;
determining an attitude of a wearer of the Bluetooth headset according to the attitude information;
controlling an Internet of Things communication device to send an emergency rescue request to a preset emergency contact in response to determining that the attitude of the wearer is a falling-to-the-ground attitude, wherein the emergency rescue request comprises any one of the following: sending rescue information to the preset emergency contact and making a rescue call to the preset emergency contact, wherein the Internet of Things communication device is built in the Bluetooth headset.

2. The control method for the Bluetooth headset according to claim 1, wherein the attitude information comprises a three-axis attitude angle and an acceleration of the Bluetooth headset.

3. The control method for the Bluetooth headset according to claim 2, wherein the attitude information is collected by an inertial measurement unit built in the Bluetooth headset.

4. The control method for the Bluetooth headset according to claim 2, wherein the determining the attitude of the wearer of the Bluetooth headset according to the attitude information comprises at least one of the following:
in response to determining that a maximum variation of the acceleration within a set duration is greater than a set variation threshold, determining that the attitude of the wearer is the falling-to-the-ground attitude;
in response to determining that the acceleration is greater than a preset acceleration threshold, determining that the attitude of the wearer is the falling-to-the-ground attitude;
determining an inclination angle of the Bluetooth headset according to the three-axis attitude angle, and in response to determining that the inclination angle is greater than a preset angle threshold, determining that the attitude of the wearer is the falling-to-the-ground attitude;
in response to determining that the maximum variation of the acceleration within the set duration is greater than the set variation threshold, determining the inclination angle of the Bluetooth headset according to the three-axis attitude angle, and in response to determining that the inclination angle is greater than the preset angle threshold, determining that the attitude of the wearer is the falling-to-the-ground attitude;
in response to determining that the acceleration is greater than the preset acceleration threshold, determining the inclination angle of the Bluetooth headset according to the three-axis attitude angle, and in response to determining that the inclination angle is greater than the preset angle threshold, determining that the attitude of the wearer is the falling-to-the-ground attitude;
in response to determining that the maximum variation of the acceleration within the set duration is greater than the set variation threshold and the acceleration is greater than the preset acceleration threshold, determining the inclination angle of the Bluetooth headset according to the three-axis attitude angle, and the inclination angle is greater than the preset angle value, determining that the attitude of the wearer is the falling-to-the-ground attitude;
in response to determining that an inclination angle of the Bluetooth headset relative to a horizontal plane, obtained through calculation on the basis of an acceleration component of a gravitational acceleration in an X-axis direction and an acceleration component in a Y-axis direction, is greater than a first angle threshold, and the inclination angle of the Bluetooth headset determined according to the three-axis attitude angle is greater than a second angle threshold, determining that the attitude of the wearer is the falling-to-the-ground attitude.

5. The control method for the Bluetooth headset according to claim 1, wherein before controlling the Internet of Things communication device to send the emergency rescue request to the preset emergency contact, the method further comprises:
starting timing from a moment when it is determined that the attitude of the wearer is the falling-to-the-ground attitude, and in response to determining that the attitude of the wearer remains in the falling-to-the-ground attitude for a first duration, entering a warning mode and outputting a first warning alert, wherein the first warning alert is used to alert the wearer that he or she is in the falling-to-the-ground attitude.

6. The control method for the Bluetooth headset according to claim 5, further comprising:
exiting the warning mode in response to an instruction for exiting the warning mode;
in response to determining that the attitude of the wearer is still the falling-to-the-ground attitude according to the attitude information within a second duration after exiting the warning mode, entering the warning mode again and outputting a second warning alert.

7. The control method for the Bluetooth headset according to claim 6, wherein before exiting the warning mode in response to the instruction for exiting the warning mode, the method further comprises:
generating the instruction for exiting the warning mode in response to detecting an operation of exiting the warning mode;
or, in response to determining that the attitude of the wearer is switched from the falling-to-the-ground attitude to a normal attitude according to the attitude information, generating the instruction for exiting the warning mode, wherein the normal attitude is an attitude other than the falling-to-the-ground attitude.

8. The control method for the Bluetooth headset according to claim 5, wherein the controlling the Internet of Things communication device to send the emergency rescue request to the preset emergency contact comprises:
in response to determining that exiting the warning mode is not detected for a third duration after entering the warning mode, controlling the Internet of Things communication device to send the emergency rescue request to the preset emergency contact.

9. The control method for the Bluetooth headset according to claim 1, further comprising:
acquiring location information of the Bluetooth headset, wherein the location information is used to indicate a location of the wearer, and the rescue information comprises the location information.

10. The control method for the Bluetooth headset according to claim 1, wherein the Bluetooth headset is installed on a helmet, and the control method further comprises:
detecting whether the Bluetooth headset falls off from the helmet;
outputting location alert information in response to determining that the Bluetooth headset is detected to fall off from the helmet.

11. The control method for the Bluetooth headset according to claim 10, wherein the outputting the location alert information comprises at least one of the following:
outputting the location alert information to a terminal connected with the Bluetooth headset through Bluetooth communication; and
outputting an alert sound through a speaker, wherein the speaker is arranged on the Bluetooth headset.

12. (canceled)

13. A Bluetooth headset, comprising:
a headset body;
a Bluetooth communication device, arranged in the headset body;
an Internet of Things communication device, arranged in the headset body;
an attitude detection device, configured to collect attitude information of the Bluetooth headset; and
a control device for the Bluetooth headset, wherein the control device is connected with the Bluetooth communication device, the Internet of Things communication device and the attitude detection device, and the control device is configured to:
acquire attitude information of the Bluetooth headset;
determine an attitude of a wearer of the Bluetooth headset according to the attitude information;
control the Internet of Things communication device to send an emergency rescue request to a preset emergency contact in response to determining that the attitude of the wearer is a falling-to-the-ground attitude, wherein the emergency rescue request comprises any one of the following: sending rescue information to the preset emergency contact and making a rescue call to the preset emergency contact.

14. A non-transitory computer-readable storage medium on which a computer program is stored, wherein the computer program, when executed by a processor, executes the steps of the control method for the Bluetooth headset according to claim 1.

15. A terminal, comprising a memory and a processor, wherein a computer program capable of running on the processor is stored in the memory, and when the processor runs the computer program, the following steps of a control method for the Bluetooth headset are executed:
acquiring attitude information of a Bluetooth headset;
determining an attitude of a wearer of the Bluetooth headset according to the attitude information;
controlling an Internet of Things communication device to send an emergency rescue request to a preset emergency contact in response to determining that the attitude of the wearer is a falling-to-the-ground attitude, wherein the emergency rescue request comprises any one of the following: sending rescue information to the preset emergency contact and making a rescue call to the preset emergency contact, wherein the Internet of Things communication device is built in the Bluetooth headset.

16. The terminal according to claim 15, wherein the attitude information comprises a three-axis attitude angle and an acceleration of the Bluetooth headset.

17. The terminal according to claim 16, wherein the attitude information is collected by an inertial measurement unit built in the Bluetooth headset.

18. The terminal according to claim 16, wherein the following steps of the control method for the Bluetooth headset are further executed:
in response to determining that a maximum variation of the acceleration within a set duration is greater than a set variation threshold, determining that the attitude of the wearer is the falling-to-the-ground attitude;
in response to determining that the acceleration is greater than a preset acceleration threshold, determining that the attitude of the wearer is the falling-to-the-ground attitude;
determining an inclination angle of the Bluetooth headset according to the three-axis attitude angle, and in response to determining that the inclination angle is greater than a preset angle threshold, determining that the attitude of the wearer is the falling-to-the-ground attitude;
in response to determining that the maximum variation of the acceleration within the set duration is greater than the set variation threshold, determining the inclination angle of the Bluetooth headset according to the three-axis attitude angle, and in response to determining that the inclination angle is greater than the preset angle threshold, determining that the attitude of the wearer is the falling-to-the-ground attitude;
in response to determining that the acceleration is greater than the preset acceleration threshold, determining the inclination angle of the Bluetooth headset according to the three-axis attitude angle, and in response to determining that the inclination angle is greater than the preset angle threshold, determining that the attitude of the wearer is the falling-to-the-ground attitude;
in response to determining that the maximum variation of the acceleration within the set duration is greater than the set variation threshold and the acceleration is greater than the preset acceleration threshold, determining the inclination angle of the Bluetooth headset according to the three-axis attitude angle, and the inclination angle is greater than the preset angle value, determining that the attitude of the wearer is the falling-to-the-ground attitude;
in response to determining that an inclination angle of the Bluetooth headset relative to a horizontal plane, obtained through calculation on the basis of an acceleration component of a gravitational acceleration in an X-axis direction and an acceleration component in a Y-axis direction, is greater than a first angle threshold, and the inclination angle of the Bluetooth headset determined according to the three-axis attitude angle is greater than a second angle threshold, determining that the attitude of the wearer is the falling-to-the-ground attitude.

19. The terminal according to claim 15, wherein the following steps of the control method for the Bluetooth headset are further executed:
starting timing from a moment in response to determining that the attitude of the wearer is the falling-to-the-ground attitude, and in response to determining that the attitude of the wearer remains in the falling-to-the-ground attitude for a first duration, entering a warning mode and outputting a first warning alert, wherein the first warning alert is used to alert the wearer that he or she is in the falling-to-the-ground attitude.

20. The terminal according to claim 19, wherein the following steps of the control method for the Bluetooth headset are further executed:
exiting the warning mode in response to an instruction for exiting the warning mode;
in response to determining that the attitude of the wearer is still the falling-to-the-ground attitude according to the attitude information within a second duration after exiting the warning mode, entering the warning mode again and outputting a second warning alert.

21. The terminal according to claim 20, wherein the following steps of the control method for the Bluetooth headset are further executed:
generating the instruction for exiting the warning mode in response to detecting an operation of exiting the warning mode;
or, in response to determining that the attitude of the wearer is switched from the falling-to-the-ground attitude to a normal attitude according to the attitude information, generating the instruction for exiting the warning mode, wherein the normal attitude is an attitude other than the falling-to-the-ground attitude.
